(19) United States
(12) Patent Application Publication
(10) Pub. No.: US 2008/0276676 A1
(43) Pub. Date: Nov. 13, 2008

(54) Solidification Material

(75) Inventors: Daisuke Sawaki, Chiba (JP); Susumu Sano, Chiba (JP); Kenichi Homma, Chiba (JP); Kouki Ichitsubo, Chiba (JP); Kenichi Matsumoto, Chiba (JP); Makihiko Ichikawa, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TAIHEIYO CEMENT CORPORATION, Tokyo (JP)

(21) Appl. No.: 11/576,604

(22) PCT Filed: Oct. 4, 2004
(86) PCT No.: PCT/JP04/14599

§ 371 Date: Apr. 4, 2007

(51) Int. Cl. C05F 7/00

(52) U.S. Cl. 71/25

(57) ABSTRACT

A soil improvement material comprising a ground burned product A and gypsum, the burned product A having a hydraulic modulus (H.M.) of 1.8 to 2.3, a silica modulus (S.M.) of 1.3 to 2.3, and an iron modulus (I.M.) of 1.3 to 2.8. The soil improvement material is useful for improving the ground, especially through solidifying soft soil, such as water-rich soil or organic-rich soil.

### TECHNICAL FIELD

The present invention relates to a soil improvement material for improving ground, and more particularly to a soil improvement material suitable for improving water-rich soil, organic-rich soil and the like.

### BACKGROUND ART

In the field of civil engineering industry or construction industry, it has heretofore been common to make effective use of the sludged soft ground accumulated near an area of river, lake or sea, and solidify it with a soil improvement material. Besides, a soil improvement material is used to prevent the recurrence of such sludge that could be piled up in the process of a civil engineering/construction carried out in an area of rivers lake or sea.

As an example of such soil improvement materials, there is a report disclosing a soil improvement material produced by mixing calcined paper sludge ash (burning temperature: 800-900° C.; 50-70 mass %, with fine powder of minute blast furnace slag (10 mass %), lime or quicklime (10-20 mass %), and anhydrous gypsum or gypsum hemihydrate (10-20 mass %) (cf. Patent Document 1).

However, these soil improvement materials are still problematic in that the target strength of them is sometimes difficult to obtain when applied to certain kinds of soils (e.g., soils of high water content, soils of high organic-substance content, etc.), even if used in large amounts. Moreover, the soil obtained by such an improvement treatment is sometimes poor in durability.

### [Patent Document 1] JP-A-2002-88362

### DISCLOSURE OF THE INVENTION

### Problems to be Solved by the Invention

In view of the foregoing, an object of the present invention is to provide a soil improvement material suitable for solidifying soft soil; e.g., water-rich soil or organic-rich soil.

### Means for Solving the Problems

Under the above circumstances, the present inventors have conducted extensive studies and have found that when a ground burned product having specified hydraulic, silica, and iron moduli is used in combination with gypsum, there can be obtained a soil improvement material suitable for solidifying soft soils; e.g., water-rich soil or organic-rich soil. The present invention has been achieved on the basis of this finding.

Accordingly the present invention provides a soil improvement material comprising a ground burned product A and gypsum, the burned product A having a hydraulic modulus (H.M.) of 1.8 to 2.3, a silica modulus (S.M.) of 1.3 to 2.3, and an iron modulus (I.M.) of 1.3 to 2.8.

### EFFECT OF THE INVENTION

The soil improvement material according to the present invention provides a high strength even when it is applied to soft soil such as soil of water-rich soil or organic-rich soil. Also, the solidified soil has excellent durability.

Moreover, since the burned product can be produced from industrial waste, non-industrial waste, or soil generated by construction, the present invention can contribute to effective utilization of wastes.

### BEST MODE FOR CARRYING OUT THE INVENTION

The burned product A employed in the present invention has a hydraulic modulus (H.M.) of 1.8 to 2.3, preferably 2 to 2.2. A hydraulic modulus of lower than 1.8 indicates a low 3CaO.SO₂(C₃S) content of the burned product, which attains only a low initial strength of the solidified soil. Also, burning to produce the burned product A becomes difficult. Further, when a hydraulic modulus is larger than 2.3, the rate of long-term strength gain of the solidified soil is slow although initial strength gain of the solidified soil is good.

Silica modulus (S.M.) of the burned product A is generally 1.3 to 2.3, preferably 1.5 to 2. When silica modulus is lower than 1.3, burning for providing the burned product A becomes difficult, whereas when silica modulus is higher than 2.3, not only strength gain of the solidified soil is unsatisfactory but also the 3CaO.Al₂O₃(C₃A) content and the 4CaO.Al₂O₃ Fe₂O₃(C₄AF) content of the burned product decrease, to thereby make burning of the burned product A difficult.

Iron modulus (I.M.) of the burned product A is generally 1.3 to 2.8, preferably 1.5 to 2.6. When iron modulus is lower than 1.3, not only grindability of the burned product A deteriorates but also initial strength gain of the solidified soil is unsatisfactory. When iron modulus is higher than 2.8, the C₃A content of the burned product becomes high, requiring increased amounts of gypsum to be added for achieving a target solidification performance which is disadvantageous from the economical point of view.

As used herein hydraulic modulus (H.M.), silica modulus (S.M.), and iron modulus (I.M.) are respectively represented by the following expressions.

Hydraulic modulus(H.M.)=(CaO−0.7×SO₃)/(SiO₂Al₂O₃Fe₂O₃)

Silica modulus(S.M.)=SiO₂/(Al₂O₃+Fe₂O₃)

Iron modulus(I.M.)=Al₂O₃/Fe₂O₃ [Formula 1]

The burned product A can be prepared from widely employed portland cement clinker materials: i.e. CaO sources such as limestone, quicklime, and slaked lime; SiO₂ sources such as silica and clay; Al₂O₃ sources such as clay; Fe₂O₃ sources such as iron slag and iron cake.

Also, according to the present inventions burned product A may be prepared from one or more species selected from among industrial waste, non-industrial waste, and soil generated by construction. Examples of the industrial waste include ready mixed concrete sludge and other types of sludge (e.g., sewage sludge, filtration plant sludge, construction sludge, and sludge from iron-making processes), construction scrap materials, concrete scrap, soil discharged from boring, different types of ash from incinerators, casting sand, rock wool, glass waste, and secondary ash from blast furnaces. Examples of the non-industrial wastes include dry granulated sewage sludge, incineration ash of municipal wastes, and shells of shellfishes; and examples of the soil generated by construction include excavated earth and residual soil from building- or road-construction sites, and waste soil.

These raw materials are mixed so as to attain a predetermined hydraulic, silica, and iron moduli, and burned preferably at 1200 to 1550° C., more preferably 1310 to 1450° C., to thereby give a burned product A.

No particular limitation is imposed on the method for mixing the raw materials, and conventional apparatuses may be used. Also, no particular limitation is imposed on the apparatus employed to perform burning, and a rotary kiln may be used. When a rotary kiln is used for burning, wastes serving as alternative fuels; such as waste oil, used tires, and waste plastics, may be used.

No particular limitation is imposed on the gypsum employed in the present invention Examples of the gypsum include gypsum (CaSO₄.2H₂O) α and β gypsum hemihydrates, and anhydrous gypsum. These may be used singly or in combination of two or more species. In particular, from the viewpoints of strength gain and durability of the solidified soil, use of anhydrous gypsum is preferred.

In the soil improvement material of the present invention, the gypsum content (as calculated in terms of SO₃) is preferably 1 to 15 mass parts, more preferably 3 to 10 mass parts, with respect to 100 mass parts ground burned product A, from the viewpoints of strength gain and durability of the solidified soil.

The soil improvement material of the present invention may be prepared by, for examples through either of the following methods:

(1) a method in which a burned product A and gypsum are ground simultaneously;

(2) a method in which a burned product A is ground, and, gypsum is added to the ground burned product A.

When method (1) is employed, preferably, the burned product A and gypsum are ground to have a Blaine specific surface area of 2500 to 4500 cm²/g, more preferably 3000 to 4500 cm²/g.

When method (2) is employed, burned product A is ground to have a Blaine specific surface area of preferably 2500 to 4500 cm²/g, more preferably 3000 to 4500 cm²/g, and gypsum is ground to have a Blaine specific surface area of preferably 2500 to 7000 cm²/g, more preferably 3000 to 6000 cm²/g.

Preferably, the soil improvement material of the present invention has a Blaine specific surface area of 2500 to 4500 cm²/g, more preferably 3000 to 4500 cm²/g from the viewpoints of the strength gain and durability of the solidified soil and costs of raw materials of the soil improvement material.

The soil improvement material of the present invention may contain one or more inorganic powders selected from among blast furnace slag powder, fly ash, limestone powder, silica powder, and silica fume. Incorporation of any one of these inorganic powders will increase the long-term durability of the solidified soil.

The blast furnace slag powder, fly ash, limestone powder and silica powder have a Blaine specific surface area of preferably 3000 to 10000 cm²/g, more preferably 4000 to 9000 cm²/g in view of the strength gain and durability of the solidified soil and costs of raw materials of the soil improvement material. Also, silica fume has a BET specific surface area of preferably 5 to 25 m²/g, more preferably 5 to 20 m²/g.

When blast furnace slag powder is employed, the inorganic powder content of the soil improvement material is preferably 150 mass parts or less, more preferably 20 to 100 mass parts, on the basis of 100 mass parts of ground burned product A, in consideration of strength gain, durability, etc. of solidified soil. When fly ash, limestone powder, or silica powder is employed, they are preferably used in amounts of 10 to 100 mass parts, more preferably 20 to 80 mass parts, on the basis of 100 mass parts of ground burned product A Likewise, when silica fume is employed, the silica fume content is preferably 1 to 50 mass parts or less, more preferably 5 to 30 mass parts, on the basis of 100 mass parts of ground burned product A.

A soil improvement material containing an inorganic powder may be prepared any one of the following methods:

(3) a method in which an inorganic powder is added to and mixed with a soil improvement material composed of a burned product A and gypsum,

(4) a method in which gypsum is added to and mixed with a co-around product of a burned product A and an inorganic powder,

(5) a method in which gypsum and an inorganic powder are added to and mixed with a ground burned product A,

(6) a method in which a burned product A, gypsum, and an inorganic powder are simultaneously ground.

The thus-produced inorganic-powder-containing soil improvement material has a Blaine specific surface area of preferably 2500 to 5000 cm²/g, more preferably 3000 to 4500 cm²/g, in consideration of strength gain, durability, etc. of the resultant solidified soil.

The soil improvement material of the present invention may further optionally contain a burned product B which contains 100 mass parts of 2CaO.SiO₂ (C₂S) and 10 to 2000 mass parts of 2CaO.Al₂O₃.SiO₂ (C₂AS), and contains 3CaO.Al₂O₃ (C₃A) in an amount of 20 mass parts or less. Incorporation of such a burned product B will increase the long-term durability of the resultant solidified soil.

As described above, the burned product B contains C₂S and C₂AS, wherein the C₂AS content is 10 to 2000 mass parts, preferably 10 to 200 mass parts, more preferably 10 to 100 mass parts, on the basis of 100 mass parts of C₂S When the C₂AS content is smaller than 10 mass parts, burning becomes difficult, and produced C₂S is prone to be of the y type having no hydrating property, and as a result, long-term strength of solidified soil cannot be sufficiently increased. On the other hand, when the C₂AS content is higher than 2000 mass parts, effect of increasing the long-term strength of solidified soil is no longer commensurate to the amount of C₂AS.

The burned product B generally has a C₃A content of 20 mass parts or less, preferably 10 mass parts or less, with respect to 100 mass parts of C₂S. When the C₃A content is in excess of 20 mass parts, the long-term strength of solidified soil cannot be sufficiently increased.

The burned product B may be produced from commonly employed raw materials of a portland cement clinker; i.e., CaO sources such as limestone, quicklime, and slaked lime; SiO₂ sources such as silica and clay; Al₂O₃ sources such as clay; and Fe₂O₃ sources such as iron slag and iron cake.

Alternatively, the burned product B may be prepared from one or more types of waste selected from among industrial waste, non-industrial waste, or soil generated by construction. Examples of the industrial waste include coal ashes, ready mixed concrete sludge and other types of sludge (e.g., sewage sludge, filtration plant sludge, construction sludge, and sludge from iron-making processes); soil discharged from boring, different types of ash from incinerators, casting sand, rock wool, glass waste, secondary ash from blast furnaces, construction scrap materials, and concrete scrap. Examples of the non-industrial waste include dry granulated sewage sludge, incineration ash of municipal wastes, and shells of shellfishes Examples of the soil generated by construction include excavated earth and residual soil from building- or road-construction sites, and waste soil.

Depending on the raw materials of the burned product B, particularly when the raw materials are one or more types of waste selected from among the aforementioned industrial waste, non-industrial waste, and soil generated by construction, 4CaO.Al₂O₃.Fe₂O₃ (C₄AF) may be formed. However, in burned product B, a portion of C₂AS, preferably 70 mass % or less of C₂AS may be replaced by C₄AB. When C₄AF is replaced in amounts beyond this limit, temperature range for burning is narrowed and production of burned product B becomes difficult to control.

The mineral composition of the burned product B can be calculated from the following equations using the CaO, SiO₂, Al₂O₃, and Fe₂O₃ contents (mass %) of the raw material(s) employed.

C₄AF=3.04×Fe₂O₃

C₃A=1.61×CaO−3.00×SiO₂−2.26×Fe₂O₃

C₂AS=−1.63×CaO+3.04×SiO₂−2.69×Al₂O₃+0.57×Fe₂O₃

C₂S=1.02×CaO+0.95×SiO₂−1.69×Al₂O₃−0.36×Fe₂O₃

When raw materials as described above are mixed to have a predetermined composition and burned at a temperature of preferably 1000 to 1350° C., more preferably 1150 to 1350° C., a burned product B can be produced.

No particular limitation is imposed on the method for mixing the raw materials, and conventional devices may be used. Also, no particular limitation is imposed on the burning apparatus, and, for example, a rotary kiln may be used. When burning is performed in a rotary kiln, wastes serving as an alternative fuel; e.g., waste oil, waste tires, and waste plastics, may be used.

In order to attain satisfactory strength gain, durability, etc. of solidified soil, a ground burned product B is contained preferably in an amount of 10 to 100 mass parts, more preferably 20 to 60 mass parts, for 100 mass parts of a ground burned product A.

A soil improvement material containing a ground burned product B may be prepared by any one of the following methods.

(7) a method in which a burned product A, a burned product B, and gypsum are simultaneously ground;

(8) a method in which a burned product A and a burned product B are simultaneously ground, and to the resultant granules, gypsum is added and mixed;

(9) a method in which a burned product A and gypsum are simultaneously ground, and to the resultant granules, a ground burned product B is added and mixed;

(10) a method in which a burned product B and gypsum are simultaneously ground, and to the resultant granules a ground burned product A is added and mixed;

(11) a method in which a burned product A and a burned product B are separately around to thereby produce ground products and gypsum is added to and therewith;

(12) a method in which an inorganic powder is added to and mixed with any one of the products resulting from the methods as described in items (7) to (11).

In method (7) burned product A, burned product B, and gypsum are preferably ground to have a Blaine specific surface area of 2500 to 4500 cm²/g, more preferably 3000 to 4500 cm²/g from the viewpoints of strength gain, durability etc. of the solidified soil.

In method (8) burned product A and burned product B are preferably ground to have a Blaine specific surface area of 2500 to 4500 cm²/g, more preferably 3000 to 4500 cm²/g, and gypsum preferably has a Blaine specific surface area of 2500 to 7000 cm²/g, more preferably 3000 to 6000 cm²/g.

In method (9) burned product A and gypsum are preferably ground to have a Blaine specific surface area of 2500 to 4500 cm²/g, more preferably 3000 to 4500 cm²/g, and burned product B is preferably ground to have a Blaine specific surface area of 2500 to 4500 cm²/g, more preferably 3000 to 4500 cm²/c.

In method (10), burned product B and gypsum are preferably ground to have a Blaine specific surface area of 2500 to 4500 cm²/g, more preferably 3000 to 4500 cm²/g, and burned product A is preferably ground to have a Blaine specific surface area of 2500 to 4500 cm²/g, more preferably 3000 to 4500 cm²/g.

In method (11), burned products A and B are preferably ground to have a Blaine specific surface area of 2500 to 4500 cm²/g, more preferably 3000 to 4500 cm²/g, and gypsum is preferably ground to have a Blaine specific surface area of 2500 to 7000 cm²/g, more preferably 3000 to 6000 cm²/g.

A soil improvement material containing a ground burned product A, a ground burned product B, and gypsum preferably has a Blaine specific surface area of 2500 to 4500 cm²/g, more preferably 3000 to 4500 cm²/g, from the viewpoints of strength gain and durability of the solidified soil and costs of raw materials of the soil improvement material.

Also, a soil improvement material containing a ground burned product A, a ground burned product B, gypsum, and an inorganic powder preferably has a Blaine specific surface area of 2500 to 5000 cm²/g, more preferably 3000 to 4500 cm²/g, from the viewpoints of strength gain and durability of the solidified soil and costs of raw materials of the soil improvement material.

In the production of a soil improvement material of the present invention, in order to improve the strength gain and durability of solidified soil, there may also be incorporated admixtures, such as water-reducing agents (including an AE water-reducing agents, a high range water-reducing agent, and an air entraining and high range water-reducing agent) of various types (lignin, naphthalene sulfonate acid, melamine, and polycarboxylic acid).

When the ground is solidified by use of the soil improvement material of the present inventions the amount of the soil improvement material to be added may differ depending on the properties of the soil of interest, installment conditions, and required strength of the solidified soil. However, the amount is preferably 50 to 300 kg, more preferably 100 to 250 kg, per m³ of the soil to be treated.

The soil improvement material of the present invention may be added, for example, through either of the following. 1) Dry-format addition, in which a soil improvement material, in the form of powder, is added to and mixed with the soil of interest 2) Slurry-format addition, in which water is added to a soil improvement material, and the resultant slurry is added to and mixed with the soil of interest. When slurry-format addition is performed, the mass ratio of water/soil improvement material is preferably 0.5 to 1.5, more preferably 0.6 to 1.0.

### EXAMPLES

The present invention will next be described in more detail by way of examples, which should not be construed as limiting the invention thereto.

### Examples 1 to 3

### (1) Production of Burned Product A

The raw materials employed included sewage waste; soil generated by construction, and commonly employed portland cement clinkers such as limestone. The material formulations were determined so as to attain the hydraulic, silica, and iron moduli (H.M., S.M., and I.M.) in Table 1. Each composition was burned in a small rotary kiln at 1400 to 1450° C., to thereby yield a burned product A. As a fuel, not only routinely employed heavy oil, but also waste oil and waste plastics were employed. The chemical make-ups of the employed sewage waste and soil generated by construction are shown in Table 2.

The free lime content of the respective burned products was between 0.6 and 1 mass %.

TABLE 1
(Burned product A)

| Burned | Hydraulic | Silica | Iron | |
|---|---|---|---|---|
| product | modulus | modulus | modulus | |
| No. | (H.M.) | (S.M.) | (I.M.) | Remarks |
| 1 | 2.10 | 1.65 | 1.99 | Raw materials did |
| | | | | not include wastes |
| 2 | 2.10 | 1.65 | 1.99 | Sewage waste was |
| | | | | used as part of raw |
| | | | | materials |
| 3 | 2.12 | 1.95 | 1.89 | Sewage waste and |
| | | | | soil generated by |
| | | | | construction were |
| | | | | used as part of raw |
| | | | | materials |

TABLE 2

| | Ig. | | | | | | | | | |
|---|---|---|---|---|---|---|---|---|---|---|
| | loss | SiO₂ | Al₂O₃ | Fe₂O₃ | CaO | Na₂O | P₂O₅ | SO₃ | MgO | K₂O |
| Sewage | 15.0 | 30.0 | 16.1 | 8.0 | 10.9 | 4.2 | 10.7 | 0.4 | 0.01 | 0.02 |
| waste | | | | | | | | | | |
| Waste | 13.3 | 52.7 | 13.8 | 8.7 | 2.5 | 1.5 | 0.5 | 2.7 | 1.2 | 1.94 |
| soil from | | | | | | | | | | |
| a construction | | | | | | | | | | |
| site | | | | | | | | | | |

### (2) Manufacture of Soil Improvement Material

Each of the burned products A in Table 1 was ground in a batch-type ball mill until a Blaine specific surface area of 3250±50 cm²/g was obtained. To 100 mass parts of the resultant ground product, anhydrous gypsum (Blaine specific surface area: 5800 cm²/g) was added in an amount of 7 mass parts (as calculated in terms of SO₃), to thereby produce a soil improvement material.

### (3) Unconfined Compression Test

Samples were prepared in accordance with the method described in JGS 0821 “Method of preparing a sample (not compacted) of soil that has undergone stabilization treatment), and the compression strength of each sample was measured on day 7 and day 28 in accordance with JIS A 1216 “Test method for unconfined compression strength of soil.” The results are shown in Table 3.

In the test, the following soils were employed: sand soil having a water content of 30%, cohesive soil having a water content of 75%, and Kanto loam having a water content of 175% The soil improvement material was added in the following amounts: 60 kg/m³ for sand soil, 100 kg/m³ for cohesive soil, and 250 kg/m³ for Kanto loam.

TABLE 3

| | Burned | Unconfined compression strength (kN/m²) | | | | | |
|---|---|---|---|---|---|---|---|
| | product | Sand soil | | Cohesive soil | | Kanto loam | |
| | No. | Day 7 | Day 28 | Day 7 | Day 28 | Day 7 | Day 28 |
| Ex. 1 | 1 | 650 | 995 | 620 | 735 | 1035 | 1110 |
| Ex. 2 | 2 | 645 | 1002 | 610 | 728 | 1040 | 1105 |
| Ex. 3 | 3 | 551 | 892 | 525 | 657 | 890 | 976 |
| Comparative | Ordinary | 480 | 775 | 458 | 570 | 770 | 850 |
| Example | portland | | | | | | |
| | cement | | | | | | |

The data in Table 3 show that the soil improvement materials of the present invention promise excellent strength gains of the solidified soil, which are much higher than practical values.

### Examples 4 to 6

### (1) Manufacture of Soil Improvement Material

Each of the burned products A in Table 1 was ground in a batch-type ball mill until a Blaine specific surface area of 3250±50 cm²/g was obtained. To 100 mass parts of the resultant ground product, anhydrous gypsum (Blaine specific surface area=5800 cm²/g; amount=7 mass parts (as calculated in terms of SO₃)) and blast furnace slag powder (Blaine specific surface area=4500 cm²/g; amount=70 mass parts) were added and mixed, to thereby produce a soil improvement material.

### (2) Unconfined Compression Test

In a manner similar to that described for Examples 1 to 3, sludge having a water content of 400% was solidified and its compression strength was measured (on day 7 and day 28). The amount of the soil improvement material added was 200 kg per m³ of sludge. The results are shown in Table 4.

TABLE 4

Unconfined compression
strength (kN/m²)

| | Burned product No. | Day 7 | Day 28 |
|---|---|---|---|
| Ex. 4 | 1 | 395 | 720 |
| Ex. 5 | 2 | 410 | 755 |
| Ex. 6 | 3 | 375 | 690 |
| Comp. Ex. | Ordinary portland | — | 500 |
| | cement | | |

The data in Table 4 show that the soil improvement materials of the present invention which contain blast furnace slag powder promise good strength rains of the solidified soil, which are higher than practical values.

### Examples 7 to 11

### (1) Manufacture of Burned Product B

The raw materials employed were lime stone and sewage waste, and these were blended at the proportion shown in Table 5, followed by burning in a small rotary kiln at 1300° C., to thereby yield a burned product B. As a fuel, not only routinely employed heavy oil, but also waste oil and waste plastics were employed. After burning was completes the burned product was ground in a batch-type ball mill until a Blaine specific surface area of 3250 cm²/g was obtained.

TABLE 5

| Raw material composition | | Mineral composition | | | | |
|---|---|---|---|---|---|---|
| (parts by mass) | | (parts by mass) | | | | |
| Limestone | Sewage waste | f-CaO | C₂S | C₂AS | C₄AS | C₃A |
| 100 | 90 | 0.4 | 100 | 33 | 34 | 12 |

### (2) Manufacture of Soil Improvement Material

Each of the burned products A in Table 1 was ground in a batch-type ball mill until a Blaine specific surface area of 3250±55 cm²/g was obtained. To 100 mass parts of the ground product, the following materials were added at the proportions shown in Table 6, to thereby produce a soil improvement material. Anhydrous gypsum (Blaine specific surface area=5800 cm²/g), blast furnace slag powder (Blaine specific surface area=4500 cm²/g) and the above-mentioned burned product B.

### (3) Unconfined Compression Test

In a manner similar to that described for Examples 1 to 3, sludge having a water content of 400% was solidified and its compression strength was measured (on day 7 and day 28). The amount of the soil improvement material added was 200 kg per m³ of sludge. The results are shown in Table 6

TABLE 6

| | Soil improvement material | | | | | | |
|---|---|---|---|---|---|---|---|
| | (parts by mass) | | | | | Unconfined | |
| | | | | Blast | | compression | |
| | Burned | | | furnace | Burned | strength | |
| | product A | | Anhydrous | slag | product | (kN/m²) | |
| | No. | Amount | gypsum* | powder | B | Day 7 | Day 28 |
| Ex. 7 | 1 | 100 | 7 | — | 30 | 380 | 715 |
| Ex. 8 | 2 | 100 | 7 | — | 30 | 394 | 750 |
| Ex. 9 | 3 | 100 | 7 | — | 30 | 365 | 682 |
| Ex. 10 | 2 | 100 | 7 | 50 | 20 | 405 | 757 |
| Ex. 11 | 3 | 100 | 7 | 50 | 20 | 373 | 694 |

| | | | |
|---|---|---|---|
| Comparative | Ordinary portland cement | — | 500 |
| Example | | | |

*as calculated in terms of SO₃

The data in Table 6 show that the soil improvement materials of the resent invention which contain a burned product B promise good strength gains of the solidified soil, which are higher than practical values.

1. A soil improvement material comprising a ground burned product A and gypsum the burned product A having a hydraulic modulus H.M.) of 1.8 to 2.3, a silica modulus (S.M.) of 1.3 to 2.3 and an iron modulus (I.M.) of 1.3 to 2.8.

2. A soil improvement material as recited in claim 1, which further comprises one or more inorganic powders selected from among blast furnace slag powder, fly ash, limestone powder, silica powder, and silica fume.

3. A soil improvement material as recited in claim 1 or 2 which further comprises a ground burned product B, the burned product B containing 100 mass parts of 2CaO.SiO₂ and 10 to 2000 mass parts of 2CaO.Al₂O₃.O₂, and containing 3CaO.Al₂O₃ in an amount of 20 mass parts or less.

4. The soil improvement material as recited in any one of claims 1 to 3, wherein the burned product A is produced from raw material of one or more species selected from among industrial waste, non-industrial wastes and soil generated by construction.

5. The soil improvement material as recited in claim 3 or 4, wherein the burned product B is produced from raw material of one or more species selected from among industrial waste non-industrial waste, and soil generated by construction.
